(19) United States
(12) Patent Application Publication
(10) Pub. No.: US 2005/0179384 A1
(43) Pub. Date: Aug. 18, 2005

(54) Plasma display panel (PDP)

(76) Inventors: Jae-Ik Kwon, Asan-si (KR); Kyoung-Doo Kang, Seoul (KR)

Correspondence Address: Robert E. Bushnell;Suite 300, 1522 K Street, N.W., Washington, DC, 20005-1202, US

(21) Appl. No.: 11/047,626

(22) Filed: Feb. 2, 2005

(30) Foreign Application Priority Data
Feb. 18, 2004 (KR) 10-2004-0010671

(51) Int. Cl. H01J 17/49

(52) U.S. Cl. 313/583; 313/582; 313/584

(57) ABSTRACT

A Plasma Display Panel (PDP) includes: a first substrate including a plurality pairs of sustain electrodes, each of which includes an X electrode and a Y electrode separated from each other by a discharge gap, formed on a lower side thereof, and a first dielectric layer covering the pairs of sustain electrodes; a second substrate facing the first substrate and including address electrodes formed on an upper side thereof to cross the pairs of sustain electrodes, and a second dielectric layer covering the address electrodes; and a barrier rib including first barrier ribs formed on the second dielectric layer to interpose at least one address electrode therebetween, and second barrier ribs crossing the first barrier ribs to define discharge cells, in which a phosphor layer is formed. Each X electrode and each Y electrode respectively include bus electrodes, and transparent electrodes having protrusions, which are spaced apart from the second barrier ribs and corresponding to the discharge cells, and extension units extending from the protrusions and connected to the bus electrodes.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 18 Feb. 2004 and there duly assigned Serial No. 2004-10671.

### BACKGROUND OF THE INVENTION

1. Field of the Invention

The present invention relates to a Plasma Display Panel (PDP), and more particularly, to a PDP having an improved discharge efficiency resulting from the prevention of mis-discharges and the ensuring of an address voltage margin.

2. Description of the Related Art

In general, in a PDP, a glow discharge is generated by supplying a predetermined voltage to electrodes, the electrodes having a gas filled sealed space therebetween. A phosphor layer formed in a predetermined pattern is then excited by ultraviolet rays generated by the glow discharge to display an image.

PDPs can be classified as Direct Current (DC) PDPs and Alternating Current (AC) PDPs according to the driving method thereof. In addition, PDPs also can be classified as two-electrode PDPs and three-electrode PDPs according to their electrode structure. A DC PDP includes an auxiliary electrode for inducing an auxiliary discharge, and an AC PDP includes an address electrode to improve the addressing speed by dividing an address discharge from a sustain discharge.

In addition, AC PDPs can be classified as opposed discharge PDPs and surface discharge PDPs according to the arrangement of the electrodes performing the discharge. Opposed discharge PDPs include two sustain electrodes respectively disposed on substrates to generate a discharge perpendicular to the panel, and surface discharge PDPs include two sustain electrodes disposed on a same substrate to generate a discharge on a plane of the substrate.

In the PDP having the above structure, discharge cells are disposed between the substrates. In a unit discharge cell, a sustain electrode including an X electrode and a Y electrode is formed on a lower surface of a first substrate arranged at an upper portion of the discharge cell. The X electrode and the Y electrode respectively function as a common electrode and a scan electrode, and are separated from each other by a discharge gap. The X electrode and the Y electrode respectively include transparent electrodes and bus electrodes formed on lower surfaces of the transparent electrodes. The sustain electrode is covered by a first dielectric layer, and a protective layer is formed on a lower surface of the first dielectric layer.

In addition, a second substrate is disposed to face the first substrate, and an address electrode is formed on an upper surface of the second substrate. The address electrode is covered by a second dielectric layer. A phosphor layer is formed on the second dielectric layer. A discharge gas is injected in the discharge cell.

In the discharge cell having the above structure, when an address voltage is supplied between the address electrode and the Y electrode of the sustain electrode and addressed, a predetermined wall charge is formed in the discharge cell. When a sustain voltage is supplied between the X electrode and the Y electrode of the sustain electrode, the discharge is sustained. When the discharge occurs, electrical charges are generated, and the electrical charges collide with the discharge gas to form a plasma and ultraviolet rays. The ultraviolet rays cause the fluorescent material on the phosphor layer to be excited to display an image.

Pairs of sustain electrodes disposed on the discharge cells of the PDP can be formed in various structures, for example, the X electrode of the sustain electrode includes a bus electrode and a transparent electrode, connected to the bus electrode, the electrodes arranged to correspond to each discharge cell. In addition, the Y electrode includes a bus electrode and a transparent electrode, connected to the bus electrode, the electrodes arranged to correspond to each discharge cell.

In addition, the transparent electrode of the X electrode and the transparent electrode of the Y electrode protrude from their discharge cell, and are separated from each other by a discharge gap. The bus electrodes supplying voltages to the transparent electrodes are arranged to correspond to the discharge region. However, in the above described structure, since the sustain electrode is separated from the phosphor layer formed inside the barrier rib by a predetermined gap therebetween, a mis-discharge due to the distortion of the electric field caused by the phosphor layer can be prevented. However, an aperture ratio is reduced due to the opaque bus electrodes.

In order to increase the aperture ratio of the panel, ‘T’ shaped transparent electrodes are formed in a sustain electrode including an X electrode and a Y electrode. In addition, the transparent electrode of the X electrode and the transparent electrode of the Y electrode protrude from their discharge cell, and are separated from each other by a discharge gap. In addition, bus electrodes supplying voltages to the transparent electrodes are arranged to correspond to barrier ribs, that is, on non-discharge regions, thus increasing the aperture ratio.

However, portions of the transparent electrodes connected to the bus electrodes are adjacent to the phosphor layer formed inside the barrier ribs. Accordingly, a distortion of electric field due to the phosphor layer can occur. In addition, unnecessary wall charges are accumulated, and it is not easy to control the wall charges. Especially, in the discharge operation for initializing the wall charges to turn the discharge cell off after generating a discharge in the discharge cell, it is not easy to control the wall charges, and accordingly, a possibility of a mis-discharge occurring increases.

Therefore, a sustain electrode, which can perform a stable discharge operation by preventing a mis-discharge from occurring and ensuring a sufficient aperture rate, is needed.

### SUMMARY OF THE INVENTION

The present invention provides a PDP having an improved sustain electrode structure for preventing mis-discharges from occurring and for ensuring an address voltage margin, thereby improving the PDP discharge efficiency.

According to an aspect of the present invention, a PDP is provided comprising: a first substrate including a plurality of pairs of sustain electrodes arranged on a lower side thereof, each pair of sustain electrodes including an X electrode and a Y electrode separated from each other by a discharge gap, and a first dielectric layer covering the plurality of pairs of sustain electrodes; a second substrate facing the first substrate and including address electrodes arranged on an upper side thereof to cross the plurality of pairs of sustain electrodes, and a second dielectric layer covering the address electrodes; and barrier ribs including first barrier ribs arranged on the second dielectric layer to interpose at least one address electrode therebetween, and second barrier ribs crossing the first barrier ribs to define discharge cells, each discharge cell having a phosphor layer arranged therein; wherein each X electrode and each Y electrode respectively includes: bus electrodes; transparent electrodes having protrusions, spaced apart from the second barrier ribs and corresponding to the discharge cells; and extension units extending from the protrusions and connected to the bus electrodes.

The bus electrodes are preferably arranged on upper portions of the second barrier ribs to correspond to the second barrier ribs.

Each of the second barrier ribs preferably has a dual-layered structure.

The protrusion of the X electrode is preferably spaced apart from the bus electrode, and the protrusion of the Y electrode is preferably spaced apart from the bus electrode.

Respective distances between the protrusion of X electrode and the second barrier rib and between the protrusion of Y electrode and the second barrier rib are preferably in the range of 20-100 μm.

A pitch between two adjacent second barrier ribs is preferably in the range of 750-100 μm.

A pitch between two adjacent first barrier ribs is preferably ⅓ of a pitch between two adjacent second barrier ribs.

The X electrode and the Y electrode preferably further respectively include discharge enlargement units extending from the protrusions toward the bus electrodes and arranged to correspond to the discharge cells.

The X electrode and the Y electrode are preferably symmetrically arranged.

The extension units are preferably arranged on upper portions of the first barrier ribs to correspond to the first barrier ribs.

A width of the extension unit is preferably less than or equal to a width of the first barrier rib.

The PDP preferably further comprises a protective layer arranged on the lower surface of the first dielectric layer.

### BRIEF DESCRIPTION OF THE DRAWINGS

The above and other features and advantages of the present invention will become more apparent by describing in detail exemplary embodiments thereof with reference to the attached drawings in which:

FIG. 1 is a side cross-sectional view of a unit discharge cell;

FIG. 2 is a plan view of sustain electrode pairs arranged on discharge cells;

FIG. 3 is a plan view of another example of the arrangement of the sustain electrode pairs on the discharge cells;

FIG. 4 is a partial perspective view of a PDP according to an embodiment of the present invention;

FIG. 5 is a plan view of sustain electrode pairs of FIG. 4 arranged on discharge cells;

FIG. 6 is a side cross-sectional view of the PDP of FIG. 4;

FIGS. 7 and 8 are graphs of the relationships between sustain voltage and address voltage according to a distance between a transparent electrode and a second barrier rib when a pitch between the second barrier ribs is 750 μm and 1100 μm, respectively; and
FIG. 9 is a plan view of the sustain electrode pairs arranged in the discharge cells according to another example embodiment of the present invention.

### DETAILED DESCRIPTION OF THE INVENTION

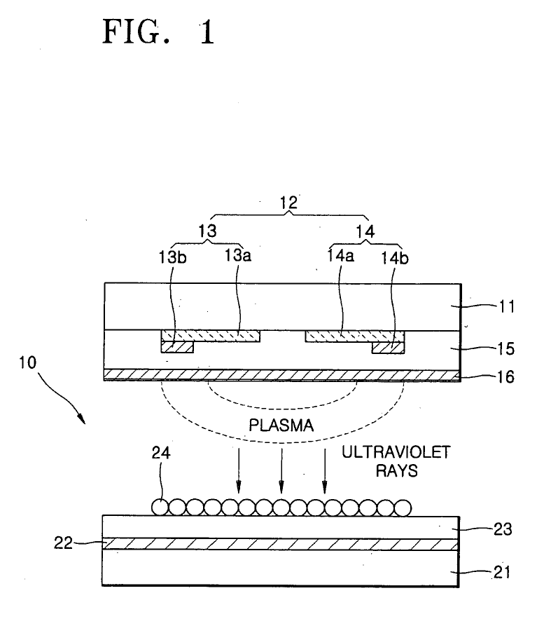

FIG. 1 is a cross-sectional view of a unit discharge cell.

Referring to FIG. 1, a sustain electrode 12 including an X electrode 13 and a Y electrode 14 is formed on a lower surface of a first substrate 11 arranged at an upper portion of a discharge cell 10. The X electrode 13 and the Y electrode 14 respectively function as a common electrode and a scan electrode, and are separated from each other by a discharge gap. The X electrode 13 and the Y electrode 14 respectively include transparent electrodes 13a and 14a and bus electrodes 13b and 14b formed on lower surfaces of the transparent electrodes 13a and 14a. The sustain electrode 12 is covered by a first dielectric layer 15, and a protective layer 16 is formed on a lower surface of the first dielectric layer 15.

In addition, a second substrate 21 is disposed to face the first substrate 11, and an address electrode 22 is formed on an upper surface of the second substrate 21. The address electrode 22 is covered by a second dielectric layer 23. A phosphor layer 24 is formed on the second dielectric layer 23. A discharge gas is injected in the discharge cell 10.

In the discharge cell 10 having the above structure, when an address voltage is supplied between the address electrode 22 and the Y electrode 14 of the sustain electrode 12 and addressed, a predetermined wall charge is formed in the discharge cell 10. When a sustain voltage is supplied between the X electrode 13 and the Y electrode 14 of the sustain electrode 12, the discharge is sustained. When the discharge occurs, electrical charges are generated, and the electrical charges collide with the discharge gas to form a plasma and ultraviolet rays. The ultraviolet rays cause the fluorescent material on the phosphor layer 24 to be excited to display an image.

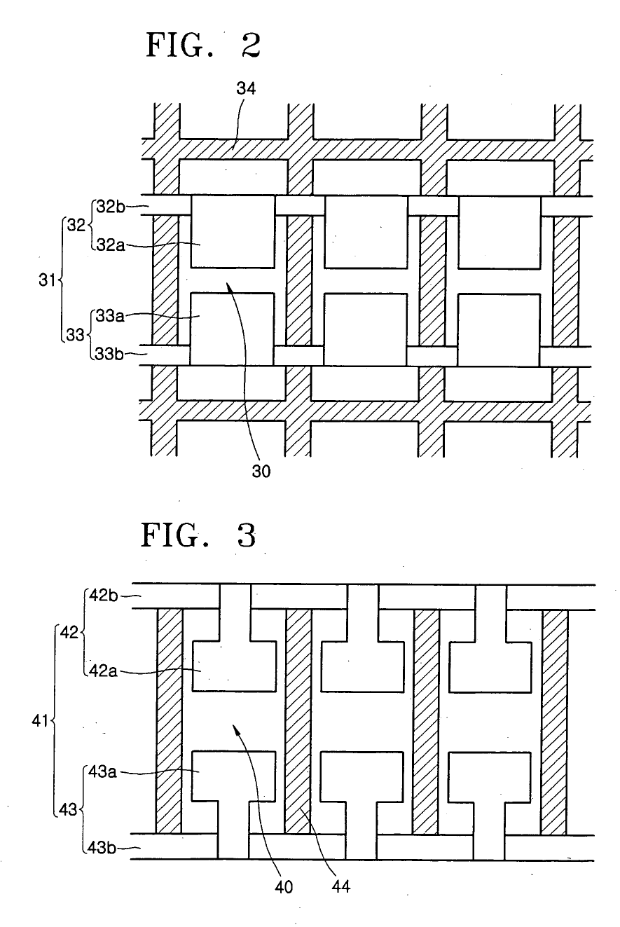

Pairs of sustain electrodes disposed on the discharge cells of the PDP can be formed in various structures, for example, in the structure shown in FIG. 2.

Referring to FIG. 2, the X electrode 32 of the sustain electrode 31 includes a bus electrode 32b and a transparent electrode 32 a, connected to the bus electrode 32b, the electrodes 32a and 32b arranged to correspond to each discharge cell 30. In addition, the Y electrode 33 includes a bus electrode 33b and a transparent electrode 33a, connected to the bus electrode 33b, the electrodes 33a and 33b arranged to correspond to each discharge cell 30.

In addition, the transparent electrode 32a of the X electrode 32 and the transparent electrode 33a of the Y electrode 33 protrude from their discharge cell 30, and are separated from each other by a discharge gap. The bus electrodes 32b and 33b supplying voltages to the transparent electrodes 32a and 33a are arranged to correspond to the discharge region. However, in the above described structure, since the sustain electrode 31 is separated from the phosphor layer formed inside the barrier rib 34 by a predetermined gap therebetween, a mis-discharge due to the distortion of the electric field caused by the phosphor layer can be prevented. However, an aperture ratio is reduced due to the opaque bus electrodes 32b and 33b.

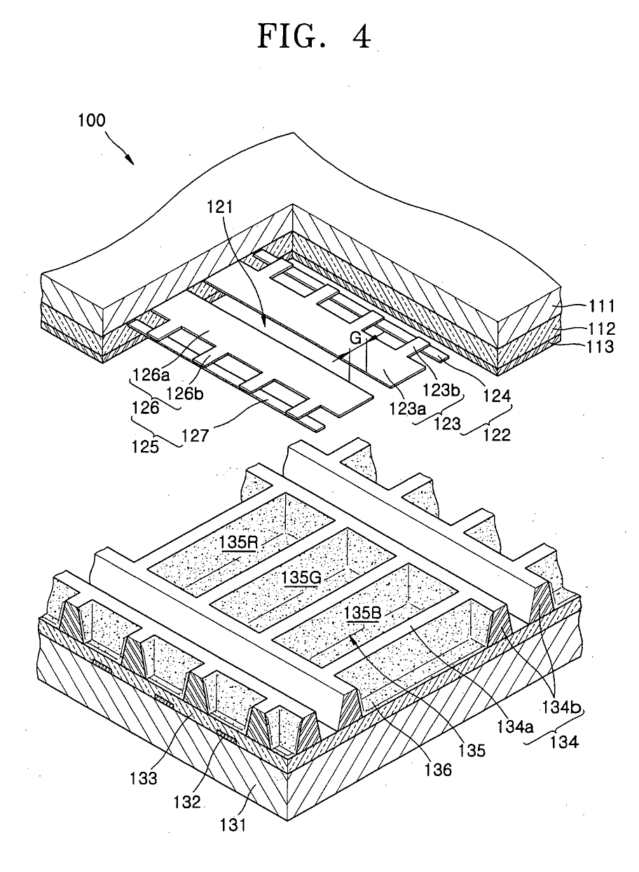

In order to increase the aperture ratio of the panel, the sustain electrode pairs can be arranged as shown in FIG. 3.

Referring to FIG. 3, ‘T’ shaped transparent electrodes 42a and 43a are formed in a sustain electrode 41 including an X electrode 42 and a Y electrode 43. In addition, the transparent electrode 42a of the X electrode 42 and the transparent electrode 43a of the Y electrode 43 protrude from their discharge cell 40, and are separated from each other by a discharge gap. In addition, bus electrodes 42b and 43b supplying voltages to the transparent electrodes 42a and 43a are arranged to correspond to barrier ribs 44, that is, on non-discharge regions, thus increasing the aperture ratio.

However, portions of the transparent electrodes 42a and 43a connected to the bus electrodes 42b and 43b are adjacent to the phosphor layer formed inside the barrier ribs 44. Accordingly, a distortion of electric field due to the phosphor layer can occur. In addition, unnecessary wall charges are accumulated, and it is not easy to control the wall charges. Especially, in the discharge operation for initializing the wall charges to turn the discharge cell 40 off after generating a discharge in the discharge cell, it is not easy to control the wall charges, and accordingly, a possibility of a mis-discharge occurring increases.

Therefore, a sustain electrode, which can perform a stable discharge operation by preventing a mis-discharge from occurring and ensuring a sufficient aperture rate, is needed.

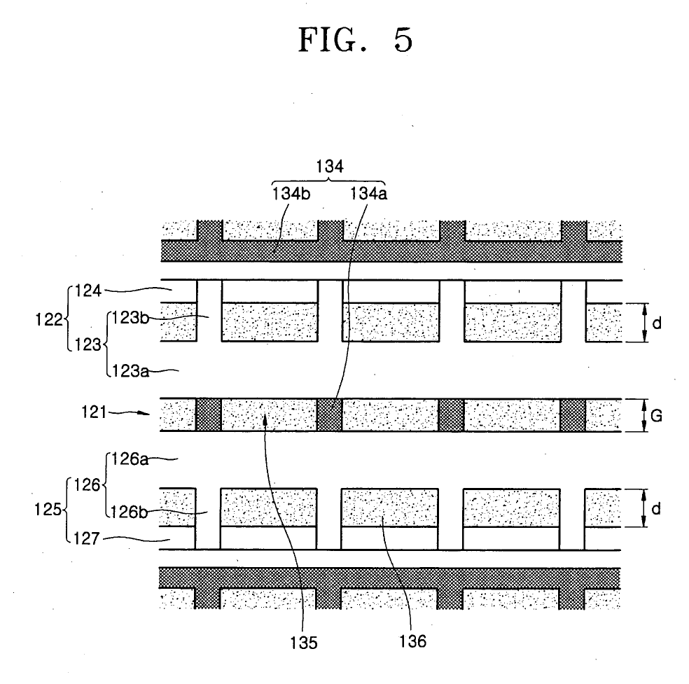

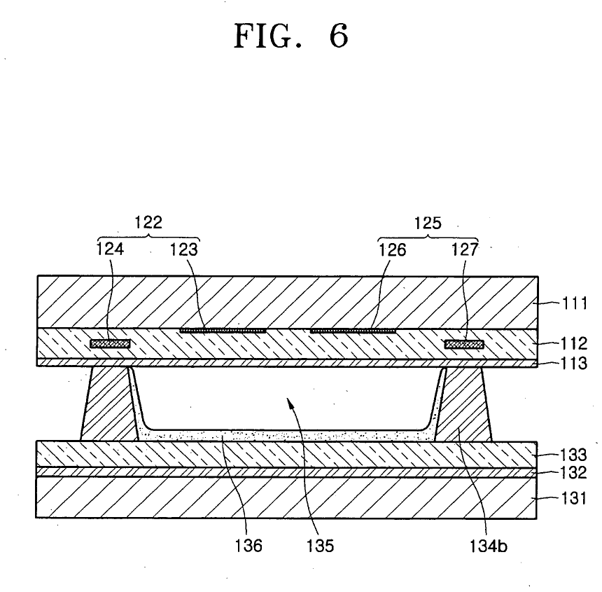

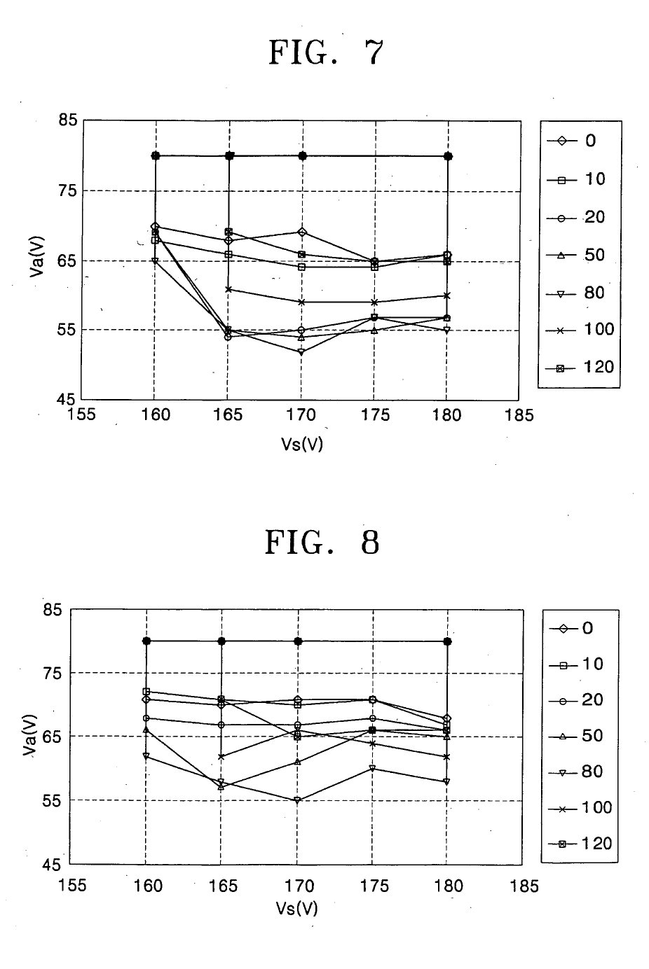

FIG. 4 is a partial perspective view of a PDP according to an embodiment of the present invention, FIG. 5 is a plan view of sustain electrode pairs of FIG. 4 arranged on the discharge cells, and FIG. 6 is a side cross-sectional view of the PDP of FIG. 4.

The PDP 100 includes a first substrate 111, and a second substrate 131 facing the first substrate 111. A plurality pairs of sustain electrodes 121 are arranged on a surface of the first substrate 111. A pair of sustain electrodes 121 includes an X electrode 122 and a Y electrode 125. The X electrode 122 corresponds to a common electrode and the Y electrode 125 corresponds to a scan electrode.

The X electrode 122 and the Y electrode 125 respectively include transparent electrodes 123 and 126 formed of Indium Tin Oxide (ITO), and bus electrodes 124 and 127 formed on sides of the transparent electrodes 123 and 126. The X electrode 122 and the Y electrode 125 will be described in more detail later.

In addition, a first dielectric layer 112 covering the pairs of sustain electrodes 121 and a protective layer 113, formed of MgO and covering the first dielectric layer 112, are formed on the first substrate 111.

Address electrodes 132 are arranged on the second substrate 131 to cross the sustain electrodes 121.

The address electrodes 132 are covered by a second dielectric layer 133, and a barrier rib 134 is formed on the second dielectric layer 133. The barrier rib 134 partitions a plurality of discharge cells 135 to prevent a cross talk from being generated between neighboring discharge cells 135.

The barrier rib 134 includes first barrier ribs 134 a separated from each other by predetermined intervals therebetween, and second barrier ribs 134b extending from side surfaces of the first barrier ribs 134a to cross the first barrier ribs 134a. The first barrier ribs 134a are arranged to interpose corresponding address electrodes 132 and are in parallel to the address electrode 132.

In addition, it is desirable for the second barrier ribs 134b to have a dual-layered structure. When the second barrier ribs 134b have the dual-layered structure, non-discharge area can be sufficiently ensured so that the bus electrode, which will be described later, can be disposed thereon. In addition, air can be exhausted through a space in the dual-layered barrier rib.

When the first and second barrier ribs 134a and 134b are formed, discharge cells 135, each of which is formed with closed four sides, are divided into a matrix pattern. If the discharge cell 135 is defined as the matrix pattern, it is advantageous for accomplishing a fine pitch, and for improving the brightness and discharge efficiency. The barrier ribs are not limited to the above example, and can be any structure that partitions the discharge cells into the pixel arrangement pattern.

A phosphor is applied on an inner side surface of the barrier rib 134 and an upper surface of the second dielectric layer 133 that is surrounded by the barrier rib 134 to form the phosphor layer 136. The color of the phosphor is red, green, or blue, thereby forming red, green, and blue color phosphor layers according to the color of the phosphor.

In addition, the discharge cells 135 can be divided into red, green, and blue discharge cells 135R, 135G, and 135B according to the color of phosphor layer 136, and three neighboring red, green, and blue discharge cells 135R, 135G, and 135B define a unit pixel. When the unit pixel is formed as a square, a pitch between neighboring first barrier ribs 134a can be ⅓ of the pitch between neighboring second barrier ribs 134b. However, the present invention is not limited thereto.

A discharge gas, in which He, Ne, and Xe are mixed, is injected into the discharge cells 135. When the discharge gas fills the discharge cells 135, the first substrate 111 and the second substrate 131 are coupled and sealed together by a sealing material, such as a frit glass, formed on edges of the first and second substrates 111 and 131.

Referring to FIGS. 4 and 5, the X electrode 122 of the sustain electrode 121 includes the transparent electrode 123 having a protrusion 123a and extension units 123b extending from the protrusion 123a, and the bus electrode 124 connected to the transparent electrode 123. The protrusion 123a of the transparent electrode 123 has a predetermined width and length, and is separated from the second barrier rib 134b and arranged at a center portion of the discharge cell 135. At an end portion of the protrusion 123a, which corresponds to the edge of the discharge cell 135, extension units 123b are extended with predetermined widths and lengths and are separated from each other. The extension units 123b are arranged to respectively correspond to the first barrier ribs 134a, and the ends of the extension units 123b are connected to one bus electrode 124. In addition, an opening is formed between the bus electrode 124 and the protrusion 123a. It is desirable the width of the each extension unit 123b be the same as that of the first barrier rib 134a or smaller.

In addition, the Y electrode 125 also includes the transparent electrode 126 having a protrusion 126a and extension units 126b extended from the protrusion 126a and the bus electrode 127 connected to the transparent electrode 126. The end portion of the protrusion 123a of the X electrode 122, arranged at the center portion of the discharge cell 135, faces the end portion of the protrusion 126a of the Y electrode 125 arranged at the center portion of the discharge cell 135, to form a predetermined discharge gap (G).

In addition, the bus electrodes 124 and 127, connected to the transparent electrodes 123 and 126, are arranged on the non-discharge area on the second barrier rib 134b in order to increase the aperture ratio of the panel. The bus electrodes 124 and 127 can be formed of Ag or Au in order to complement the line resistances of the transparent electrodes 123 and 126. A black color additive can be added into the bus electrodes 124 and 127 to increase the contrast.

As described above, in the transparent electrodes 123 and 126 of the X electrode 122 and the Y electrode 125, the protrusions 123a and 126a and the second barrier ribs 134b are separated from each other by predetermined gaps, and the bus electrodes 124 and 127 are disposed on the non-discharge area, and the region corresponding to the edge of the discharge cell 135 is formed as the opening.

According to the above structure, the transparent electrodes 123 and 126 and the phosphor layers 136 formed on the inside of the second barrier ribs 134 are separated, thus reducing the mis-discharge caused by the distorted electric field due to the interaction between the wall charges accumulated to correspond to the transparent electrodes 123 and 126 and the phosphor layer 136. In addition, the wall charges generated in the discharge cell 135 are not accumulated on the regions between the protrusions 123a and 126a and the bus electrodes 124 and 127 unnecessarily, thereby minimizing the effect of the unnecessarily accumulated wall charges on the generation and extinguishment of the electric charges and making it is easy to control the wall charges. When the wall charges are easily controlled, a stable discharge occurs in initializing the wall charges to turn off the discharge cell 135.

Moreover, since the X and Y electrodes 122 and 125 have the above structures, a sufficient address voltage margin can be ensured, and the discharge efficiency can be improved. The address voltage margin is a difference between a maximum value and a minimum value of the address voltage, by which a stable discharge can be maintained. In addition, since the opaque bus electrodes 124 and 127 are disposed in the non-discharge area, a high aperture ratio can be obtained.

The above effects can be changed according to the value of ‘d’, that is, the distance between the protrusions 123a and 126a and the second barrier ribs 134b, and accordingly, the value of ‘d’ can be optimally set. Referring to FIG. 5, the value of ‘d’, that is, the distance between the protrusions 123a and 126a and the second barrier ribs 134b, can be defined as the shortest length therebetween, that is, a length of the opening in the direction of extending the first barrier ribs 134a.

For example, the setting of the value ‘d’ that can ensure a sufficient address voltage margin is described below with reference to FIGS. 7 and 8, and Tables 1 and 2.

FIG. 7 is a graph of a relationship between sustain voltage Vs and address voltage Va according to the value of ‘d’ when the pitch between the second barrier ribs 134b is 1100 μm in the discharge cell, and Table 1 indicates the minimum values of the address voltage according to the value of ‘d’ and the sustain voltage in FIG. 7.

TABLE 1

| | | d(μm) | | | | | | |
|---|---|---|---|---|---|---|---|---|
| | | 0 | 10 | 20 | 50 | 80 | 100 | 120 |
| Va (V) | 180 | 66 | 66 | 57 | 57 | 55 | 60 | 65 |
| | 175 | 65 | 64 | 57 | 55 | 57 | 59 | 65 |
| | 170 | 69 | 64 | 55 | 54 | 52 | 59 | 66 |
| | 165 | 68 | 66 | 54 | 55 | 55 | 61 | 69 |

Referring to FIG. 7 and Table 1, the maximum value of the address voltage is 80V, and the minimum value of the address voltage gradually reduces, then increases while the value of ‘d’ increases at a constant sustain voltage value. Accordingly, the address voltage margin, that is, the difference between the maximum value and the minimum value of the address voltage, gradually increases, then reduces according to the increase of the value ‘d’. The address voltage margin is noticeably reduced when the value of ‘d’ is 0, 10, and 120 μm. Therefore, it is desirable that the value of ‘d’ is within a range of 20˜100 μm. In addition, when the value of ‘d’ is in the range of 20˜100 μm, the panel can operate stably even when the address voltage is 60V or less.

In addition, FIG. 8 is a graph of a relationship between the sustain voltage Vs and the address voltage Va according to the value of ‘d’, when the pitch between the second barrier ribs 134b is 750 μm in the discharge cell, and Table 2 indicates the minimum values of address voltage according to the value of ‘d’ and the sustain voltage in FIG. 8.

TABLE 2

| | | d(μm) | | | | | | |
|---|---|---|---|---|---|---|---|---|
| | | 0 | 10 | 20 | 50 | 80 | 100 | 120 |
| Va (V) | 180 | 68 | 67 | 66 | 65 | 58 | 66 | 66 |
| | 175 | 71 | 71 | 68 | 66 | 60 | 64 | 66 |
| | 170 | 71 | 70 | 67 | 61 | 55 | 66 | 65 |
| | 165 | 70 | 71 | 67 | 57 | 58 | 62 | 71 |

Referring to FIG. 8 and Table 2, the maximum value of the address voltage is 80V as in FIG. 7 and Table 1, and the minimum value of the address voltage is reduced gradually, then increases according to the increase of the ‘d’ value at a constant sustain voltage value. Accordingly, the address voltage margin, that is, the difference between the maximum value and the minimum value of the address voltage, increases gradually, then reduces according to the increase of the ‘d’ value. Although the address voltage margin is lower than that in case where the pitch between the second barrier ribs is 1100 μm, the panel can operate stably even when the address voltage is 70V or less when the value of ‘d’ is in the range of 20˜100 μm. Therefore, if the address voltage that can operate the panel stably is set as 70V, the value of ‘d’ can be 20˜100 μm when the pitch between the second barrier ribs is 750˜1100 μm.

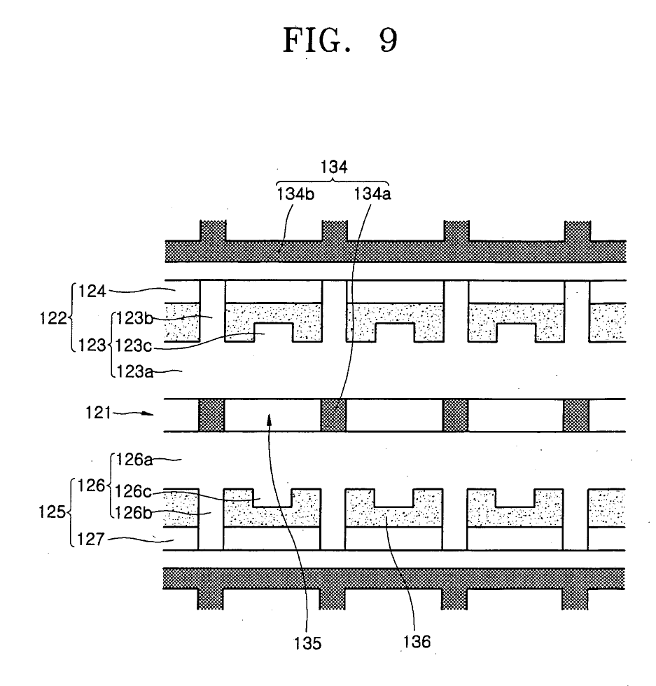

Referring to FIG. 9, the protrusions 123a and 126a of the transparent electrodes 123 and 126 in the X electrode 122 and the Y electrode 125 can further include discharge enlargement units 123c and 126c.

The discharge enlargement units 123c and 126c are extended from the protrusions 123a and 126a toward the bus electrodes 124 and 127 with predetermined widths and lengths. End portions of the discharge enlargement units 123c and 126c are separated from the bus electrodes 124 and 127 by predetermined intervals, and both sides of the discharge enlargement units 123c and 126c are predetermined distances apart from the adjacent extension units 123b and 126b.

The discharge enlargement unit 123c of the X electrode 122 and the discharge enlargement unit 126c of the Y electrode 125 are formed to have the same shapes, and accordingly, the X electrode 122 and the Y electrode 125 can be symmetric with each other. However, the shapes of discharge enlargement units are not limited thereto. When the discharge enlargement units 123c and 126c are further formed on the transparent electrodes 123 and 126 of the X and Y electrodes 122 and 125, areas of the transparent electrodes 123 and 126 can increase, and the discharge can be performed sufficiently.

As described above, according to the PDP of the present invention, since the protrusions of the transparent electrodes in the X electrode and the Y electrode are predetermined intervals apart from the second barrier ribs, mis-discharges can be prevented and the address voltage margin can be ensured, and accordingly, the discharge efficiency can be improved. In addition, since the bus electrodes connected to the transparent electrodes are disposed on the non-discharge area, the aperture ratio can be increased.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A Plasma Display Panel (PDP), comprising:
a first substrate including a plurality of pairs of sustain electrodes arranged on a lower side thereof, each pair of sustain electrodes including an X electrode and a Y electrode separated from each other by a discharge gap, and a first dielectric layer covering the plurality of pairs of sustain electrodes;
a second substrate facing the first substrate and including address electrodes arranged on an upper side thereof to cross the plurality of pairs of sustain electrodes, and a second dielectric layer covering the address electrodes; and
barrier ribs including first barrier ribs arranged on the second dielectric layer to interpose at least one address electrode therebetween, and second barrier ribs crossing the first barrier ribs to define discharge cells, each discharge cell having a phosphor layer arranged therein;
wherein each X electrode and each Y electrode respectively includes:
bus electrodes;
transparent electrodes having protrusions, spaced apart from the second barrier ribs and corresponding to the discharge cells; and
extension units extending from the protrusions and connected to the bus electrodes.

2. The PDP of claim 1, wherein the bus electrodes are arranged on upper portions of the second barrier ribs to correspond to the second barrier ribs.

3. The PDP of claim 2, wherein each of the second barrier ribs has a dual-layered structure.

4. The PDP of claim 1, wherein the protrusion of the X electrode is spaced apart from the bus electrode, and the protrusion of the Y electrode is spaced apart from the bus electrode.

5. The PDP of claim 1, wherein respective distances between the protrusion of X electrode and the second barrier rib and between the protrusion of Y electrode and the second barrier rib are in the range of 20˜100 μm.

6. The PDP of claim 5, wherein a pitch between two adjacent second barrier ribs is in the range of 750˜100 μm.

7. The PDP of claim 5, wherein a pitch between two adjacent first barrier ribs is ⅓ of a pitch between two adjacent second barrier ribs.

8. The PDP of claim 1, wherein the X electrode and the Y electrode further respectively include discharge enlargement units extending from the protrusions toward the bus electrodes and arranged to correspond to the discharge cells.

9. The PDP of claim 8, wherein the X electrode and the Y electrode are symmetrically arranged.

10. The PDP of claim 1, wherein the extension units are arranged on upper portions of the first barrier ribs to correspond to the first barrier ribs.

11. The PDP of claim 10, wherein a width of the extension unit is less than or equal to a width of the first barrier rib.

12. The PDP of claim 1, further comprising a protective layer arranged on the lower surface of the first dielectric layer.
